(19) United States
(12) Patent Application Publication
(10) Pub. No.: US 2009/0317007 A1
(43) Pub. Date: Dec. 24, 2009

(54) METHOD AND APPARATUS FOR PROCESSING A DIGITAL IMAGE

(75) Inventors: Pankaj Kumar Baipai, Bangalore (IN); Gauray Kumar Jain, Bangalore (IN); Girish Kulkarni, Bangalore (IN)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/489,127

(22) Filed: Jun. 22, 2009

(30) Foreign Application Priority Data
Jun. 20, 2008 (IN) 1518/CHE/2008

(51) Int. Cl. G06K 9/36

(52) U.S. Cl. 382/233

(57) ABSTRACT

A method for optimizing memory usage required for processing a digital image by using Minimum Coded Entity Group (MCEG) information obtained during parsing, decoding or encoding the image is provided. An MCEG is formed by processing two consecutive coded entities (Minimum Coded Units (MCUs)) of an image. The MCEG information includes distances between start positions of each MCEG from a preset location, relative distance between coded entities within an MCEG and at least four DC values. DC values of a first coded entity within an MCEG are reconstructed by using stored DC values. For a second coded entity within an MCEG, stored predictor DC values are added to decoded differential DC values to get actual values and the actual values are used for MCU reconstruction. To process a portion of an image, a closest MCEG is determined and the corresponding MCU is directly accessed and decoded using the MCEG information.

### PRIORITY

This application claims priority under 35 U.S.C. §119(a) to a Indian Patent Application filed in the Indian Intellectual Property Office on Jun. 20, 2008 and assigned Serial No. 1518/CHE/2008, the entire disclosure of which is incorporated herein by reference.

### BACKGROUND OF THE INVENTION

1. Field of the Invention

The present invention relates generally to digital image processing and more particularly to optimizing memory usage that is required for processing a high-resolution image.

2. Description of the Related Art

Many present-day portable devices such as digital cameras, mobile phones, etc. are enabled to capture high-resolution images. Some of these devices also allow the user to customize or process these high-resolution images according to the users' personal preferences. Customization of digital images is achieved through editing operations. However, portable devices, with their low memory and lesser processing capabilities, are not equipped to handle the processing of high-resolution images.

To process a portion of an image, positions of pixels in the image must be ascertained. Some image-editing transform-based effects require random pixel information to rotate, crop and flip an image. Since encoded image data is mostly represented in compressed form and employs variable length coding, tracing a particular pixel in the encoded data is not trivial. In the absence of a method that can randomly decode an image from any pixel, it becomes essential to decode the entire image and store it sequentially in a buffer before the processing can begin.

The existing methods known to process a portion of a Joint Photographic Expert Group (JPEG) image require a buffer of size W*H*2 (where ‘W’ and ‘H’ represent width and height of the pixels respectively) to store the decoded image. After the portion of the image is extracted from decoded data, image processing algorithms are applied on the extracted data and the output is stored in another buffer of size W*H*2. Thus, the entire process of editing a portion of an image requires a memory of 2*(W*H*2) plus the memory required for encoding and decoding. For a 2 Mega Pixel Image, this process would typically consume at least 8 MB of memory, which could be prohibitive in devices with low memory capabilities.

Methods in the prior art for addressing this limitation include storing encoding information related to digital image data along with image data file itself The encoding information includes DC values (coefficients) of chroma and luma components within a Minimum Coded Unit (MCU) of the image, location of the MCU within encoded image data and offsets by which MCUs are separated. U.S. Pat. No. 6,381,371, assigned to Hewlett Packard, describes storing information related to MCUs of a JPEG image in the form of a table. The stored information includes DC values of the chroma and luma components within each MCU and offset values of each MCU from a predefined location on the image. This stored information is used to locate a portion of an image. Then, only the located portion is decoded.

Though prior art methods include optimizing storage required for processing an image to some extent, the amount of memory consumed in the prior art methods is still considerable. When the resolution of an image (in megapixels) increases, the memory required to process images using the prior art methods lead to increased memory consumption. Thus, there is a further need to optimize the storage amount required to process a digital image.

### SUMMARY OF THE INVENTION

An aspect of the present invention is to provide methods and a system that eliminate or alleviate the limitations and drawbacks of the prior art, including those described above.

The present invention provides a system and method for optimizing memory usage required for processing a digital image by using Minimum Coded Entity Group (hereinafter, “MCEG”) information, which is obtained during parsing, encoding or decoding the image. An MCEG is formed from two consecutive coded entities wherein the coded entities are Minimum Coded Units (MCUs) of an image. MCEG information includes distances from a preset location to each MCEG start position and relative distance between coded entities (MCUs) within an MCEG The MCEG information can also include distance of each MCEG end position from the preset location taken at a time and length of second coded entity within an MCEG The MCEG information can further include mid-point offset information of each individual MCEG from any predetermined location on an encoded image data and difference between mid points of MCEG groups and either starting or ending points of the individual coded entities within a group. Also, the MCEG information typically includes DC values of first and last data units of non-subsampled component (for example Y-luma) of first coded entity and DC values of data units of subsampled components (for example Cb and Cr) of first coded entity of each MCEG Thus, when YCbCr 4:2:0 subsampling is applied, four DC values for each MCEG are stored. For other YCbCr formats, only a minimum number of DC values required to reconstruct the MCU are stored.

Collected MCEG Information Data (MID) is stored in a separate file, or in a primary or secondary memory, or in the same JPEG file or in RAM, or at any predetermined location. When the MID is stored in a different location such as a server, a link corresponding to the MID is provided in the JPEG file, which is used to reconstruct the image.

The DC values that are stored corresponding to the first MCU within an MCEG are taken as default values to reconstruct a first MCU. For a second MCU within the MCEG, DC values of corresponding MCEG are added to decoded differential DC values to obtain actual values, which are then used to reconstruct the second MCU. To process a portion of an image, an MCEG corresponding to the portion is determined, and the MCUs are directly accessed for decoding using MID information.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a Joint Photographic Expert Group (JPEG) image that is broken down into minimum coded entity blocks or Minimum Coded Units (MCUs), in accordance with the prior art;

FIG. 2 illustrates the arrangement of blocks in a Minimum Coded Unit (MCU) of a JPEG file, in accordance with the prior art;

FIG. 3 illustrates exemplary MCEGs formed by grouping consecutive MCUs in raster scan order, in accordance with an embodiment of the present invention;

FIG. 4 is flow chart illustrating a method for processing a digital image, in accordance with an embodiment of the present invention;

FIG. 5 illustrates a method for retrieving stored MID to process a digital image, in accordance with an embodiment of the present invention;

FIG. 6 illustrates a method for decoding an image file and generating MID, in accordance with an embodiment of the present invention;

FIG. 7 illustrates an MID table generated using the methods depicted in FIG. 5 and FIG. 6;

FIG. 8 illustrates a method for decoding a required portion of an image for processing by using the MID table, in accordance with an embodiment of the present invention;

FIG. 9 depicts a method for encoding a JPEG file after processing, in accordance with an embodiment of the present invention; and

FIG. 10 depicts a system for processing a variable length encoded binary bit stream representative of a digital image, in accordance with an embodiment of the present invention.

### DETAILED DESCRIPTION OF EMBODIMENTS OF THE INVENTION

The following description, with reference to the accompanying drawings, is provided to assist in a comprehensive understanding of certain embodiments of the present invention. Accordingly, it includes various specific details to assist in that understanding. However, these specific details are to be regarded as merely exemplary. Further, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the dictionary meanings, but are used by the inventor to enable a clear and consistent understanding of the invention. It should be apparent to those skilled in the art that the following description of embodiments of the present invention are provided for illustration purposes only and not for the purpose of limiting the present invention as will be defined by the appended claims and their equivalents.

In the accompanying figures, similar reference numerals may refer to identical or functionally similar elements. These reference numerals are used in the detailed description to illustrate various embodiments and to explain various aspects and advantages of the present invention.

The present invention includes a method of generating processing information corresponding to encoded blocks of a digital image and using the processing information to decode a portion of the digital image for processing.

The present invention will now be described, by way of example, with reference to the accompanying drawings.

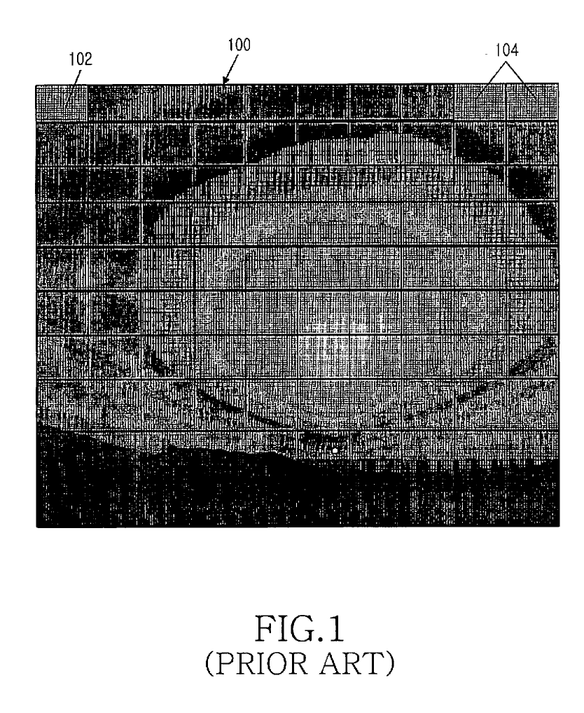

FIG. 1 illustrates a JPEG image that is broken down into minimum coded entity blocks. This JPEG image is stored as a series of compressed image tiles referred to as Minimum Coded Units (MCUs). The MCUs of a JPEG image are typically 8×8, 16×8 or 16×16 pixels in size. The variations in pixel sizes are due to chroma subsampling in which colour information in the image is sampled at a lower resolution to discard additional information that is not noticeable by a human observer. The highlighted block 102 represents a minimum coded block or an MCU. Two adjacent MCUs can be grouped together to form a Minimum Coded Entity Group (MCEG) 104.

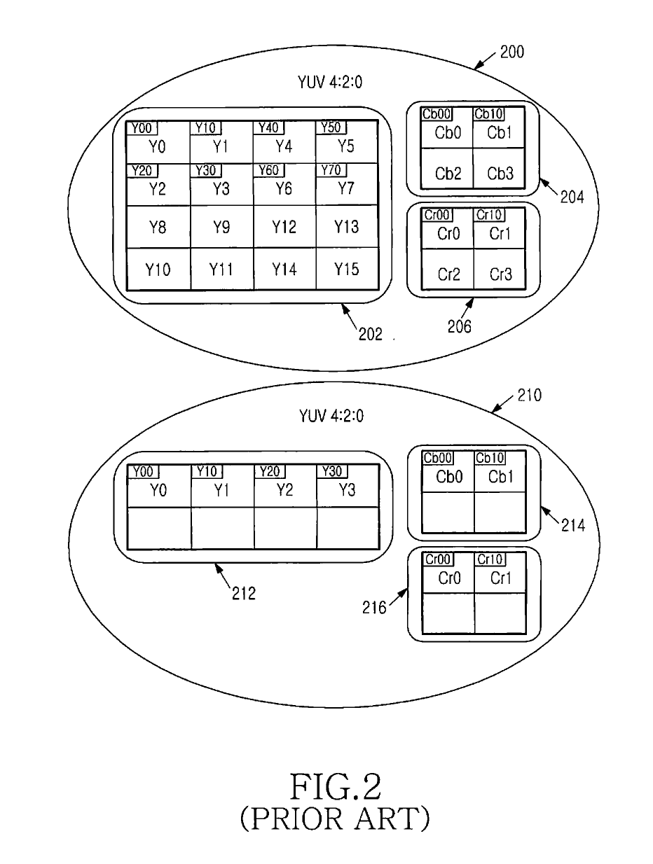

FIG. 2 illustrates the arrangement of blocks in a Minimum Coded unit (MCU) of a JPEG file. Since images are generally represented in raw color format (specifically, in the RGB 8:8:8 representation), memory required to store images of higher resolution (in Megapixels) is very high. Typically, for 1600×1200 (2M pixel) images, the amount of memory required for storage in raw color format is 5.76 MB (1600*1200*3 bytes/pixel). Thus, digital images are usually represented in compressed formats and JPEG is one of the known image compression standards. The image information in JPEG format is stored in the form of Minimum Coded Units (MCUs) in raster scan order. Each MCU contains varying number of blocks [200, 210] of chroma (related to colour) [204, 206, 214, 216] and luma (related to brightness) [202, 212] components based upon horizontal and vertical chroma sub-sampling. Each component block (usually of 8×8 pixels in size) in which the 0th coefficient represents DC and the rest represent AC, is transformed using Discrete Cosine Transform (DCT). The transformed component block is then quantized to give 8×8 quantized DCT values.

For Example:

For YUV 420 subsampling [200], the 8×8 blocks (Y0,Y1, . . . Cb0,C1, . . . ) are arranged in MCUs as shown below:

MCU0→Y0,Y1,Y2,Y3,Cb0,Cr0

MCU1→Y4,Y5,Y6,Y7,Cb1,Cr1

For 4 MCUs in case of YUV 422 subsampling [210], there are 8 Luma blocks [212], 4 Cb blocks [214] and 4 Cr blocks [216]. The blocks are arranged in MCUs as shown below:

MCU0→Y0,Y1,Cb0,Cr0

MCU1→Y2,Y3,Cb1,Cr1

The quantized data units are ten encoded using the Huffman method to give variable length codes. Thus, the length of an MCU in a JPEG image is variable.

The quantized DC value of each block is differentially encoded with respect to quantized value of previous block of same component. In the figure, only a fixed number of chroma components, luma components and quantized DC values of chroma and luma components have been included for the sake of explanation. It should be understood by a person ordinarily skilled in the art that quantized DC values are selectively stored corresponding to all subsampled and non-subsampled components in an image data file.

Let E depict values to be encoded and let Y00, Cb00, Cr00, Y10, Cb10, Cr10 . . . represent quantized DC values corresponding to MCU blocks. The DC values are then differentially encoded a follows:

For YUV 420 subsampling:

EY00=Y00−0 EY10=Y10−Y00

EY20=Y20−Y10 EY30=Y30−Y20

ECb00=Cb00−0 ECr00=Cr00−0

EY40=Y40−Y30 EY50=Y50−Y40

EY60=Y60−Y50 EY70=Y70−Y60

ECb10=Cb10−Cb00 ECr10=Cr10−Cr00

For YUV 422 subsampling:

EY00=Y00−0 EY10=Y10−Y00

ECb00=Cb00−0 ECr00=Cr00−0

EY20=Y20−Y10 EY30=Y30−Y20

ECb10=Cb10−Cb00 ECr10=Cr10−Cr00

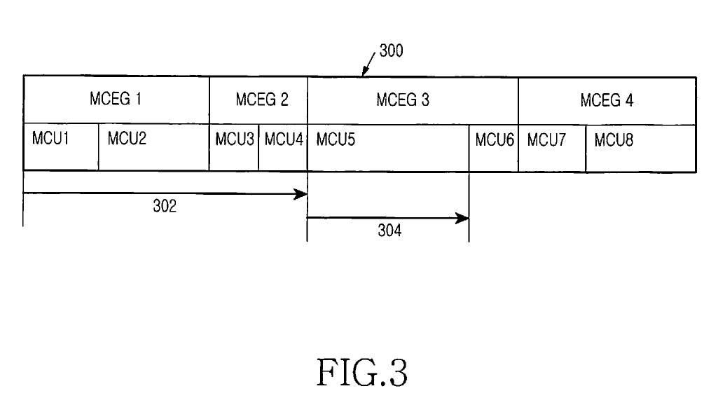

FIG. 3 depicts exemplary MCEGs formed by grouping consecutive MCUs in raster scan order. Since Huffman coding on raw image data results in generating varying length codes, it can be observed from the figure that sizes of each MCU within an MCEG vary when compared to the ones in other MCEGs. In the figure, MCU1 and MCU2 are grouped to form the first MCEG Similarly, other MCEGs are formed by grouping adjacent MCUs in raster scan order. Distance of each MCEG from a predefined start location is stored as a first offset value (Offset 1) for each MCEG. Relative distance between two MCUs within a MCEG is stored as a second offset value (Offset 2) for each MCEG. For example, the distance from a start location to a third MCEG of a first MCU is stored as Offset 1 [302] and the relative distance between MCU5 and MCU6 within MCEG3 are stored as Offset 2 [304].

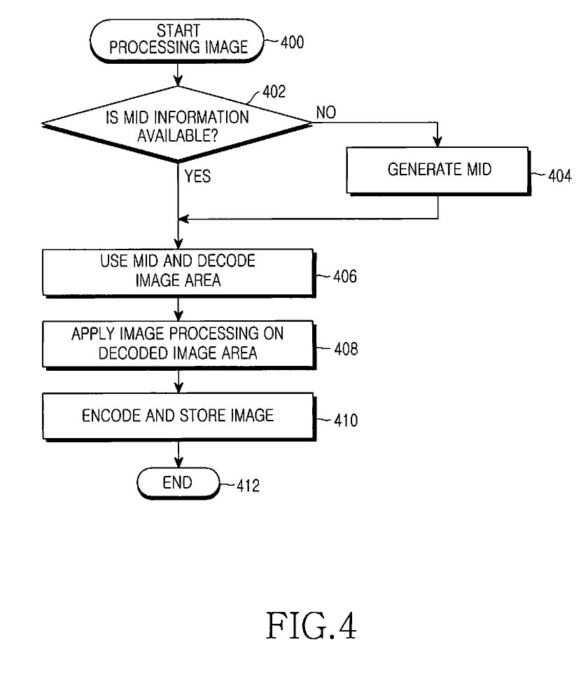

FIG. 4 illustrates a method for processing a digital image according to an embodiment of the present invention. In step 400, digital image processing begins. In step 402, presence of any existing MID is determined. If the MID is already present, an image area is decoded using stored MID in step 406. Corresponding to each MCEG, DC values of data units within each MCU block and offset information are retrieved from the MID. If the MID is not already present, the MID is generated and stored in step 404. The MID can be stored as metadata along with the image file. The MID can also be stored separately and a link to the MID can be provided in the image data file. In step 406, the MID is then used for image decoding and MCUs are reconstructed. After image data has been reconstructed, image processing operations are applied on the reconstructed image data in step 408. After image processing, an image file is encoded and is stored in the JPEG image format. MID information generated corresponding to the encoded MCU blocks is generated.

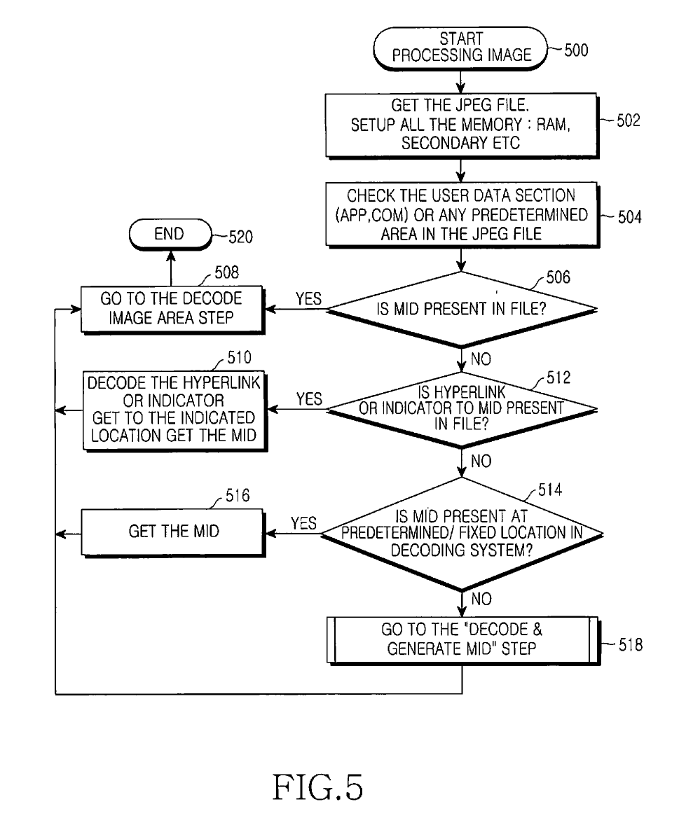

FIG. 5 illustrates a method for retrieving stored MID to process a digital image. In step 502, JPEG image processing begins. In step 506, the presence of any MID within JPEG image file is determined. The MID is usually stored as a part of metadata of a digital image file. If the MID is not stored along with the file, in step 512, the JPEG image file is checked for the presence of a hyperlink or an indicator to MID. In step 514, a search for the presence of MID corresponding to the JPEG image file is conducted in a predefined storage location. Once the MID is retrieved from any of the locations mentioned in steps 506, 512 and 514, the JPEG image is decoded using the retrieved MID as illustrated in step 508. If the MID or a link to the MID is not available anywhere, the method of decoding and generating MID is performed according to step 518.

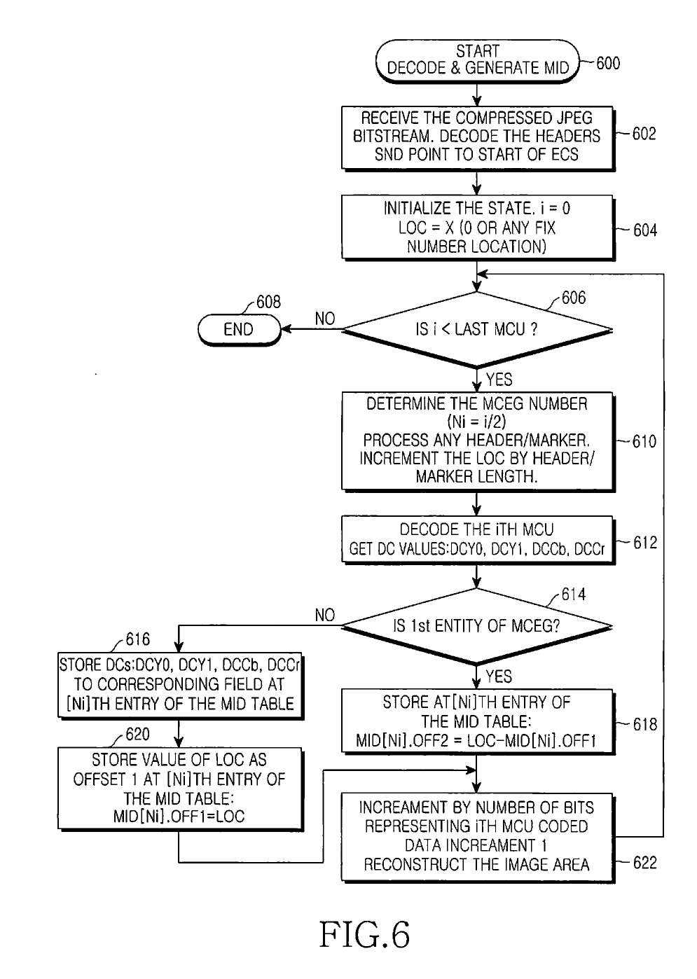

FIG. 6 illustrates a method for decoding an image file and generating MID. According to a preferred embodiment of the present invention, MID is generated when a user accesses a JPEG image file that does not have any stored MID information. However, the MID can also be generated when an image captured using a camera is encoded in JPEG format. In step 602, a compressed binary bit stream representative of image data is sequentially accessed from the start of a JPEG image file. A Minimum Coded Entity Group (MCEG) is formed from two consecutive MCUs at a time in raster scan order. In step 604, a parameter(i) for defining order of MCEGs and MCUs, and a parameter(loc) for indicating an address of stored MCEGs and MCUs are initiated. In step 606, it is determined whether the parameter(i) is lower than a last MCU. Next, in step 610, when the parameter(i) is lower than the last MCU, a MCEG number(Ni) is determined and the parameter(loc) is increased in accordance with header/marker length.

In step 612, every MCU within an MCEG is decoded and DC values of luma (Y) and chroma components (Cb and Cr) are retrieved for each MCU. Depending on the type of subsampling employed, the number of component DC values stored in each MCU may vary. For example, when YCbCr 4:2:0 subsampling is employed, four DC values are stored. The four DC values correspond to first and last DC values of non-subsampled component (Luma Y0 and Y1 (last)) of first coded entity (MCU) within the MCEG and DC values of subsampled chroma components (Cb and Cr) of first coded entity within an MCEG In step 614, it is determined whether i^{th} MCU is first entity of MCEG. If the i^{th} MCU is first entity of MCEG, step 616 is processed, and if the ith MCU is not first entity of MCEG, step 618 is processed. In step 616, DC values (for example, DCY0, DCY1, DCCb, DCCr) are stored in a field corresponding to a [Ni]^{th} entry of the MID table.

In step 620, the distance of the MCEG from a predefined start location is stored as first offset information (represented as Offset 1(MID[Ni].off1)). The predefined start location can be a first MCU block in the image data file. For example, the value of the parameter(loc) is stored in the [Ni]th entry of the MID table(MID[Ni].off1) as the first offset information.

Meanwhile, in step 618, relative distance between the coded entities (MCUs) within a MCEG is stored as second offset information (represented as Offset 2(MID[Ni].off2)). For example, a first offset information (MID[Ni].off1) deducted from the value of the parameter(loc) can be used as the second offset information.

The four DC values and offset information collected for an MCEG together represent MCEG information. MCEG information is collected across all MCU groups and this collective information is stored in a table as MCEG Information data (MID).

The collected MCEG Information Data is stored in a separate file, or in a primary or secondary memory, or in the same image file or in RAM, or at any predetermined location. In a preferred embodiment of the present invention, the MID is stored in a table along with metadata of the image file. However, the MID can also be stored in a different location such as a server and a link corresponding to the MID can provided in the image file or in the primary or secondary memory.

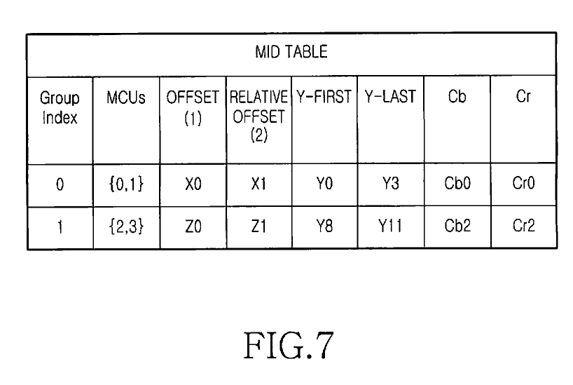

FIG. 7 illustrates a MID table generated using the methods depicted in FIGS. 5 and 6. The MID is first generated while a captured image is encoded or while an encoded image is accessed for the first time. The MID table is populated with MCEG information obtained from individual entity groups. In case of YCbCr 4:2:0 subsampling, four DC values, as described in step 616, are stored for each MCEG. MCEG information includes the distance from each MCEG start position to a preset location and relative distances between coded entities within an MCEG. The MCEG information can also include the distance of each MCEG end position from the preset location taken at a time and lengths of each second coded entity within an MCEG. The MCEG information can further include mid-point offset information of each individual MCEG from any predetermined location and difference between mid points of the group and either the starting or ending points of individual coded entities within an MCEG.

Since the number of data units present in each of the chroma and luma components varies according to the type of subsampling, storage of MCEG information can be optimized as follows:

A. When YCbCr 4:2:0 or YCbCr 4:2:2 subsampling is used, at least four DC values are stored for each MCEG. The four DC values correspond to first and last DC values of non-subsampled component (Y Luma) of the first coded entity (MCU) within each MCEG, and DC values of subsampled chroma components (Cb and Cr) of the first coded entity within an MCEG.

B. When a chroma component is used in full resolution according to YCbCr 4:4:4, at least three DC values are stored for each MCEG. The three DC values correspond to one DC value each of Y, Cb and Cr of the first coded entity within an MCEG.

C. In single component case (YCbCr 4:0:0), one DC value corresponding to the Y luma of the first coded entity is stored.

As two MCUs are grouped into an MCEG, the memory required for storing DC values is reduced by four bytes per MCEG compared to the prior art. Also, storage of offset information is optimized, as fewer bytes are required to store relative offset information (2 bytes in this case), as opposed to absolute offset information (4 bytes). To store MCEG information in case of YCbCr 4:2:0 subsampling, the following is required:

8 bytes for storing 4 DC values (2 byte per value)

4 bytes to store MCEG offset information (from a predetermined location)

2 bytes for storing relative offset information of 2^{nd} MCU within a MCEG.

Thus, in total, 14 bytes are required to store MCEG information, which amounts to 7 bytes per MCU.

The MID information thus generated using MCEG information reduces memory required for storage by saving at least 6 bytes per MCEG (3 bytes per MCU) when compared to the existing art. The amount of memory saved in case of an image with higher resolution is considerable according to the method of the present invention.

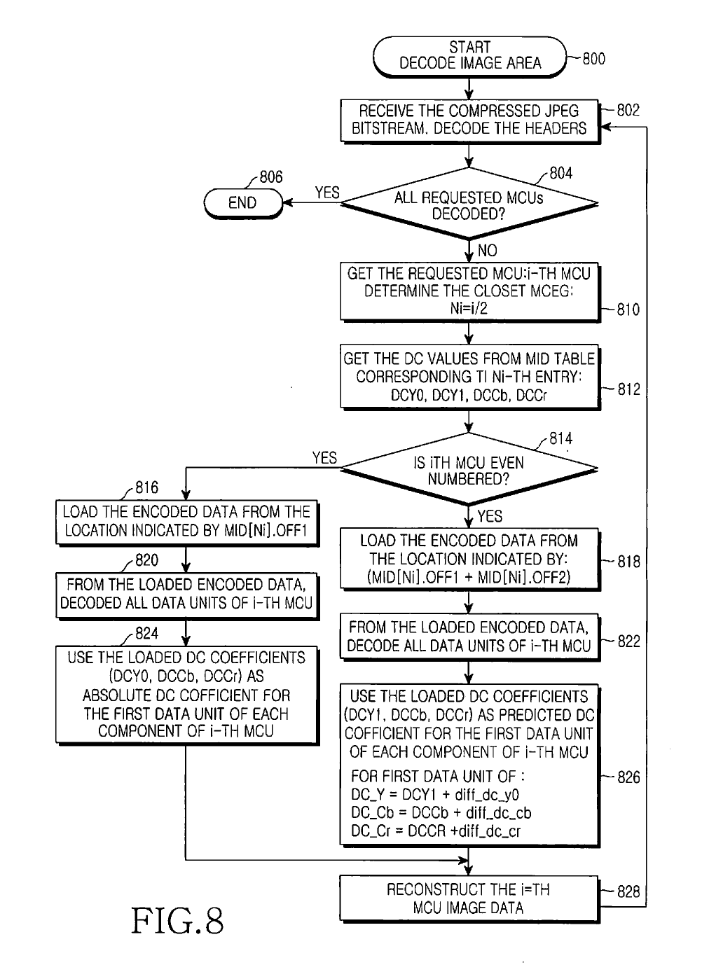

FIG. 8 illustrates a method for decoding a required portion of an image for processing by using MID as depicted in the table of FIG. 7.

In step 800, a procedure for decoding a part of image date is initiated. In step 802, a compressed JPEG bitstream is received and headers included in the bitstream are decoded. In step 804, it is determined whether all requested MCUs are decoded. If all requested MCUs are decoded, the method is ended via step 806. Meanwhile, if all requested MCUs are not decoded, step 810 is processed for decoding the requested MCUs.

At step 810, MCUs (and thus MCEGs) corresponding to the portion of an image to be edited are determined. For each identified MCEG, corresponding DC values and offset information are retrieved from the MID table in step 812. The DC values and offset information will be used to reconstruct MCUs within the MCEG In step 814, it is determined whether an MCU within the identified MCEG is even numbered or odd numbered. If the MCU is even numbered, then all data is retrieved from an MCU located at “Offset 1” as illustrated in step 816. In step 820, the retrieved data of step 816 is decoded and all data units are extracted. In step 824, DC values corresponding to the extracted data units of step 824 are treated as absolute DC values and are used to reconstruct the MCU. If the MCU is odd numbered, the DC values from the MCEG are used as predictor DC values. Then, a location is determined by adding the value of “Offset 1” to “Offset 2” and all data present at the determined location are retrieved in step 818. In step 822, data units are extracted from the retrieved data and these extracted data units represent the differential DC values. In step 826, predictor DC values are added to differential DC values to obtain actual DC values, which are used to reconstruct the MCU in step 828. In essence, DC values of corresponding MCEG are taken as default values to reconstruct a first MCU. For a second MCU within the MCEG, DC values of corresponding MCEG are added to differential DC values of second MCU to obtain actual values, which are then used to reconstruct the second MCU.

All MCUs present in the portion of the image to be processed are reconstructed using stored MID to obtain decoded image data. Image processing operations like flipping, cropping, rotating etc. are then applied on the decoded image data which result in processed MCUs.

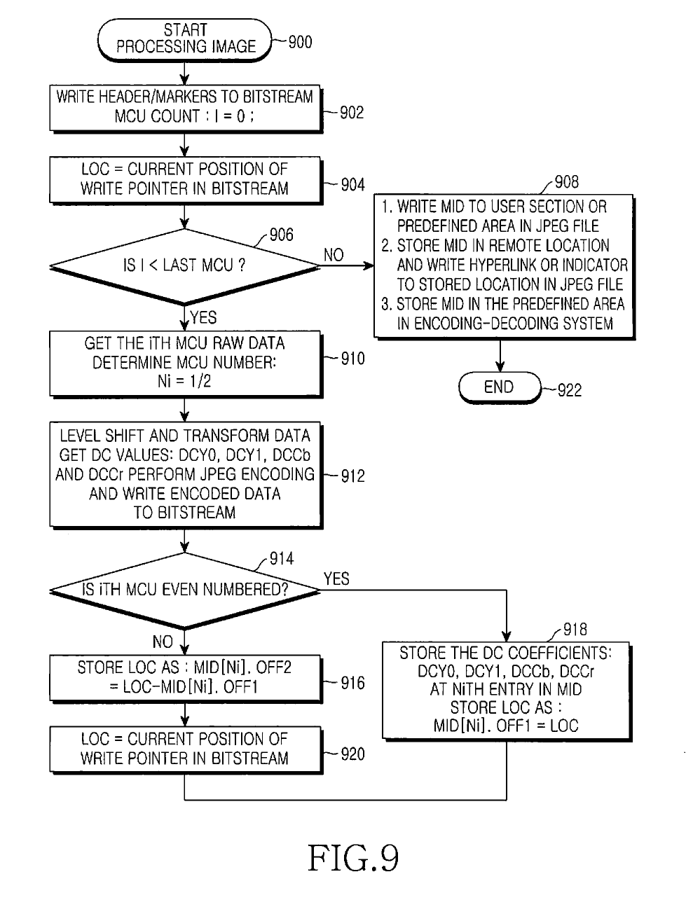

FIG. 9 depicts a method for generating MID information during encoding of a JPEG file. As per existing JPEG image standards, encoding starts with writing headers and markers into a bit stream of the JPEG file as indicated in step 902. In addition, in step 902, headers and markers are written to bitstream and MCU count parameter(I) is initiated. In step 904, a value of parameter(LOC) is set as current position of write pointer in bitstream. In step 904, it is determined whether the parameter(I) is lower than last MCU. In step 906, when the parameter(I) is lower than last MCU, step 910 is processed, and when the parameter(I) is greater than or equal to the last MCU, step 908 is processed.

In step 910, raw image data corresponding to coded entity (MCU) is obtained. In step 912, DC values are obtained for each MCU by level shifting and transforming the image data. JPEG encoding is then performed on the image data and encoded data is written into the image bit stream. In step 914, it is determined whether an MCU is even numbered or odd numbered. If the MCU is even numbered, four DC values corresponding to Y0, Y1, Cb0 and Cr0 and a location value (equal to Offset 1) are stored in an MID table as indicated in step 918. If the MCU is odd numbered, then relative distance between MCUs within an MCEG is stored as Offset 2 as indicated by step 916. In step 908, the newly generated MID information is written into a user section or any predefined area of the JPEG file or in primary or secondary memory. This generated MID can also be stored in a remote location and a hyperlink or indicator to the location can be written into the JPEG file. The encoding of the image can also be performed in a number of ways by using the methods in the existing art or in ways known to a person ordinarily skilled in the art.

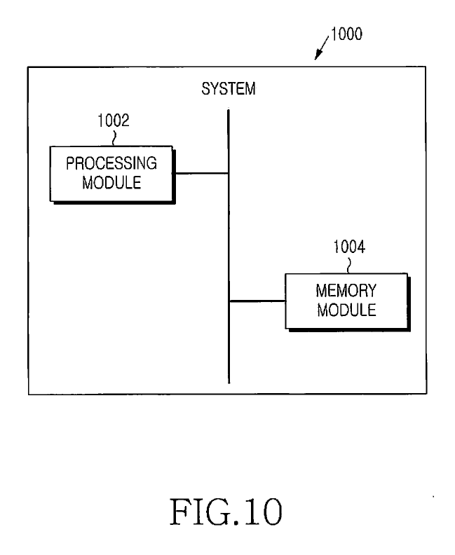

FIG. 10 depicts a system 1000 for processing a variable length encoded binary bit stream representative of a digital image, in accordance with an embodiment of the present invention. Examples of the system according to the present invention include an image processor and an electronic device. Examples of electronic devices include, but are not limited to digital cameras, mobile phones, pocket Personal Computers (PCs), portable computers and desktop computers. The system according to an embodiment of the present invention includes a processing module 1002 and a memory module 1004. The processing module 1002 is configured to group two consecutive Minimum Coded Units (MCUs) in the encoded image data file to form a Minimum Coded Entity Group (MCEG). All the MCUs from the encoded image data file are grouped into a plurality of MCEGs by processing two MCUs at a time in raster scan order. The processing module then collects information from each of the MCEGs. The memory module is configured to store the information collected by the processing module as MCEG Information Data (MID). When a user selects a portion of a digital image for processing, the processing module identifies MCEGs corresponding to the selected portion of the image from the stored MID. The processing module then uses the MID stored corresponding to the MCEGs to decode the MCUs within each MCEG. The processing module then reconstructs image data using decoded MCUs. Processing operations are then applied on the reconstructed image data. The processing operations include, but are not limited to zooming an image, cropping a portion of the image, flipping the image and rotating the image.

While the embodiments of the present invention have been illustrated and described, it will be clear that the present invention and its advantages are not limited to these embodiments only. Numerous modifications, changes, variations, substitutions and equivalents will be apparent to those skilled in the art without departing from the spirit and scope of the present invention as described in the claims.

What is claimed is:

1. A method for processing image data, the method comprising:
dividing the image data into Minimum Coded Units (MCUs) and encoding the divided MCUs into an encoded image data file;
grouping at least two of the MCUs in the encoded image data file to form a Minimum Coded Entity Group (MCEG), wherein a plurality of MCEGs are formed from the encoded image data file;
collecting information from each of the plurality of MCEGs; and
storing the information collected from the plurality of MCEGs as MCEG Information Data (MID), wherein the MID is a part of processing information of the digital image.

2. The method of claim 1, further comprising:
selecting a portion of the encoded image data file for processing;
identifying at least one MCEG corresponding to the selected portion of the encoded image data file;
decoding at least one of the MCUs present in each of the at least one identified MCEGs; and
processing the decoded MCUs to form processed MCUs.

3. The method of claim 2, further comprising accessing encoded image data for processing.

4. The method of claim 2, wherein decoding comprises reconstructing the MCUs using DC values stored corresponding to the identified MCEGs in the MID.

5. The method of claim 4, wherein a first MCU in each of the at least one identified MCEGs is reconstructed using a first predetermined offset and absolute DC values stored corresponding to the identified MCEG in the MID.

6. The method of claim 5, wherein the first predetermined offset represents distances between start positions of at least one of the identified MCEGs and a first MCU in the image data file.

7. The method of claim 4, wherein a second MCU in each of the at least one identified MCEGs is reconstructed using DC values at a second predetermined offset in the encoded image data file and using absolute DC values stored corresponding to the MCEGs in the MID.

8. The method of claim 7, wherein the second predetermined offset represents the relative distance between MCUs within each of the at least one identified MCEGs.

9. The method of claim 1, wherein grouping is achieved by processing two consecutive MCUs in raster scan order.

10. The method of claim 1, wherein the collected information comprises distances from a predetermined start position to a start position of each MCEG.

11. The method of claim 10, wherein each MCEG is identified using the distance from the predetermined start position to the start position of the MCEG stored in the MID.

12. The method of claim 10, wherein the predetermined start position is a first MCU in the encoded image data file.

13. The method of claim 1, wherein the collected information comprises a relative distance between MCUs within each MCEG

14. The method of claim 13, wherein each MCEG is identified using a relative distance corresponding to the MCEG stored in the MID.

15. The method of claim 1, wherein the collected information comprises at least one DC value corresponding to data units of a first MCU within each MCEG.

16. The method of claim 15, wherein a first DC value and a last DC value corresponding to each non-subsampled component in the first MCU are stored.

17. The method of claim 15, wherein a first DC value corresponding to each subsampled component in the first MCU are stored.

18. The method of claim 1, further comprising generating MID position information indicating a position of the stored MID and storing the MID position information.

19. An electronic device configured to process image data, the electronic device comprising:
a processing module configured to group at least two Minimum Coded Units (MCUs) in an encoded image data file that includes the image data to form a Minimum Coded Entity Group (MCEG), wherein a plurality of MCEGs are formed from the encoded image data file, collect information from each of the plurality of MCEGs, identify at least one MCEG corresponding to a selected portion of the encoded image data file, decode the MCUs present in each of the at least one identified MCEGs using stored MID, and process the decoded MCUs to form processed MCUs; and
a memory module configured to store collected MCEG Information Data (MID).
